(19) United States
(12) Patent Application Publication
(10) Pub. No.: US 2025/0192224 A1
(43) Pub. Date: Jun. 12, 2025

(54) SOLID-STATE CONDUCTOR MATERIALS

(71) Applicant: THE UNIVERSITY OF LIVERPOOL, Liverpool (GB)

(72) Inventors: Alexandra MORSCHER, Liverpool (GB); Matthew DYER, Liverpool (GB); Matthew ROSSEINSKY, Liverpool (GB); John CLARIDGE, Liverpool (GB); Luke DANIELS, Liverpool (GB)

(21) Appl. No.: 18/845,050

(22) PCT Filed: Mar. 8, 2023
(86) PCT No.: PCT/GB2023/050554

§ 371 Date: Sep. 9, 2024

(30) Foreign Application Priority Data
Mar. 9, 2022 (GB) 2203303.9

(51) Int. Cl. H01M 10/0562; H01M 10/0525

(52) U.S. Cl. CPC H01M 10/0562; H01M 10/0525; H01M 2300/0071; H01M 2300/008

(57) ABSTRACT

A solid crystalline material of formula (I): LiₐMY₄XZ: wherein: a is from 5 to 8: M is selected from Si, Al, Sb, Sn, B, Ga and Ge, a mixture thereof, or a mixture thereof comprising P₁₋ₓM′ wherein M′ is selected from Si, Al, Sb, Sn, B, Ga and Ge or a mixture thereof and wherein 0<x≤1; wherein when M is Si at least one of X and Z is O; Y is O_{1-b}S_{b}, wherein b is from 0 to 0.5; and X and Z are each independently selected from O, S, F, Cl, Br, I or a mixture thereof. The solid crystalline material suitably provides a solid ionic conductor for use in a solid-state battery. A solid crystalline material comprising a solid solution, a solid-state battery comprising the solid crystalline material and a method of preparing the solid crystalline are also disclosed.

### FIELD

The present invention relates to a solid crystalline material, a method of preparing the solid crystalline material and the use of the solid crystalline material as a solid ionic conductor. In particular, the present invention relates to a new class of solid crystalline materials which may find utility as solid ionic conductors, for example as solid electrolytes in solid-state lithium ion batteries.

### BACKGROUND

Lithium ion batteries comprise an anode, a non-aqueous electrolyte, a separator and a cathode. Organic electrolytes (primarily based on linear and cyclic alkyl carbonates) are typically used because of the wide operating voltage they provide. However, such organic electrolytes have high volatility and flammability, posing a serious safety issue for their use in the consumer electronics and transportation markets. When exposed to extreme conditions (such as elevated voltage and temperature), organic liquid electrolytes can react with the active electrode materials to release significant heat and gas, leading to fires and possibly explosions. There is therefore a need to provide safer, alternative electrolytes with comparable or superior ion conduction.

Recent advances in lithium ion battery technology have involved the use of solid electrolytes provided by inorganic solid ion conductors, as replacements for organic liquid electrolytes. These inorganic solid ion conductors conduct electricity by the passage of ions through an otherwise rigid crystal structure. Usually, only one type of ion (either cations or anions) is predominantly mobile and conducts electricity in the solid electrolyte. Ionic conductors are potentially useful in batteries, sensors and solid oxide fuel cells.

Achieving conductivities in such solid electrolytes which are comparable to those of existing liquid electrolytes remains a challenge due to the reduced mobility of the ions. One approach to achieve a desirable conductivity is based on doping various elements into the crystal structure of the solid ion conductor, for example to produce structures where oxide and sulfide are the anion. However, this often results in sub-optimal physical properties of the solid electrolyte which hinders processing of the material in the manufacture of batteries. Some current lithium ion conducting solid electrolytes have low ionic conductivity and high elastic constants which hinder processing (e.g. Li₇La₃Zr₂O₁₂, Li_{1.3}Al_{0.3}Ti_{1.7}(PO₄)₃), whilst others have poor stability and low elastic constants (e.g. Li₆PS₅I and Li₁₀GeP₂S₁₂) which hinders performance.

The lithium-containing argyrodites are a family of lithium ion conductors with potential application in solid-state batteries. Materials such as Li₆PS₃Br have sufficient ionic mobility for such applications. However, their stability in air and against metallic lithium are a concern, and their soft mechanical properties make processing the materials challenging. Replacing the sulfide ions with oxide ions to provide Li₆PO₅Cl and Li₆PO₅Br has the potential to improve stability and mechanical properties but this suffers from a concurrent drop in ionic conductivity to values below useful levels.

### SUMMARY OF THE INVENTION

It is one aim of the present invention, amongst others, to provide a solid crystalline material that addresses at least one disadvantage of the prior art, whether identified here or elsewhere, or to provide an alternative to existing solid crystalline materials. For instance, it may be an aim of the present invention to provide a solid crystalline material which can be used as a solid ionic conductor for use in lithium ion batteries.

According to aspects of the present invention, there is provided a solid crystalline material, a battery comprising such a solid crystalline material, a method of preparing such a solid crystalline material and use of the solid crystalline material as set forth in the appended claims. Other features of the invention will be apparent from the dependent claims, and from the description which follows.

According to a first aspect of the present invention, there is provided a solid crystalline material of formula (I):

LiₐMY₄XZ;

wherein:
a is from 5 to 8;
M is selected from Si, Al, Sb, Sn, B, Ga and Ge, or a mixture thereof or comprises P₁₋ₓM′ₓ; wherein M′ is selected from Si, Al, Sb, Sn, B, Ga and Ge, or a mixture thereof and wherein 0<x≤1;
wherein when M is Si and at least one of X and Z is O;
Y is O_{1-b}S_{b}, wherein b is from 0 to 0.5; and
X and Z are each independently selected from O, S, F, Cl, Br, I or a mixture thereof.

Each of the M, M′, X and Z atoms can be present in mixtures of atoms selected from the lists above and therefore are not necessarily present in stoichiometric amounts.

As noted above, current oxide argyrodites (Li₆PO₅Cl and Li₆PO₅Br) do not show the fast ion conduction of their sulphide counterparts. In the materials of this first aspect, alternative “M” species or mixtures of P and other such “M” species are used to obtain materials which have conductivities high enough for use as a solid electrolyte in thin-film solid state batteries and/or as protective coatings in conventional lithium ion batteries. Advantageously, these materials can be synthesised at relatively low temperatures for oxide-based materials (e.g. 550° C.) and therefore may be formed using significantly less energy than known materials used in the same applications. Furthermore, the materials of this first aspect may contain only earth abundant elements, which may have the advantages of good availability and low cost of starting materials. The materials of this first aspect may also offer better stability than the sulphide alternatives. Also, the materials of this first aspect suitably have mechanical properties which lie between the soft sulphides and brittle oxides, which may be advantageous for the applications discussed herein.

The solid crystalline material of this first aspect suitably comprises a highly ordered microscopic structure forming a crystal lattice extending in three dimensions. The solid crystalline material is suitably formed from a unit cell which repeats in three dimensions to form a three-dimensional lattice structure. As will be known by the skilled person, a unit cell is characterized by six parameters. These parameters are three edges (a, b and c) and angles between them (a, B and Y). Suitably, using these parameters, a unit cell may be defined as cubic, tetragonal, orthorhombic, monoclinic, hexagonal or triclinic.

The solid crystalline material of the first aspect suitably has an argyrodite crystal structure.

The solid crystalline material of the first aspect suitably has a crystal structure with a space group selected from F4̅3m, F4̅3c, P2₁3, P6₃cm, Pmn2₁, Pna2₁, or Cc.

The solid crystalline material of the first aspect suitably comprises a high symmetry structure, minimising anisotropic effects on ionic conductivity. This is a significant advantage over materials of the prior art having lower symmetry that may be used as solid electrolytes.

For the avoidance of doubt, the species mentioned above (Li, Si, Al, Sb, Sn, B, Ga, Ge P, O, F, Cl, Br and I) suitably have their normal charges in the solid crystalline material of this first aspect, for example Li⁺, Si⁴⁺, O²⁻, Cl⁻. Suitably the solid crystalline material of the first aspect is overall charge neutral. The formula (I) is suitably charge balanced to provide such a charge neutral material.

In the solid crystalline material of this first aspect, the group “M” is provided by either Si, Al, Sb, Sn, B, Ga and Ge, or a mixture thereof, or by P₁₋ₓM′ₓ wherein M′ is selected from Si, Al, Sb, Sn, B, Ga and Ge, or a mixture thereof and wherein 0<x≤1.

Therefore in some embodiments, the group “M” is Si, Al, Sb, Sn, B, Ga and Ge, or a mixture thereof. By a mixture thereof we mean that the material may contain at least two of these different species to provide the one “M” group in the formula LiₐMY₄XZ. In such embodiments, the material may be considered to be a mixture of two different compounds, for example LiₐSiY₄XZ and LiₐAlY₄XZ. Such a mixture is suitably a solid solution having an intermediate composition between the two extremes, LiₐSiY₄XZ and LiₐAlY₄XZ for example. In such a solid solution, the “M” species in each particular compound will be either Si or Al, in a random order and according to the relative abundance of each present in the formula.

Suitably M is Si, Al, Sb, Sn or a mixture thereof.

In some embodiments, M is Si. In such embodiments, at least one of X and Z is O and therefore the material has the formula: LiₐSiY₄OZ.

In such embodiments, Y is suitably O so the material has the formula: LiₐSiO₅Z.

In such embodiments, a is suitably 7. Suitably Z is Cl or Br. Suitably Z is Cl. Suitably the solid crystalline material has the formula Li₇SiO₅Cl.

In some embodiments, M is P₁₋ₓM′ₓ; wherein M′ is selected from Si, Al, Sb, Sn, B, Ga and Ge, or a mixture thereof and wherein 0<x≤1. Therefore the material may have the formula: LiₐP₁₋ₓM′ₓY₄XZ.

In such embodiments, a is suitably from 6 to 7. The a value may vary from 6 to 7 according to the amount of the M′ species present. Suitably M′ is Si. Therefore the material of this embodiment suitably has the formula (II):
Li₆₊ₓP₁₋ₓSiₓY₄XZ;
   wherein:
0<x≤1;
Y is O_{1-b}S_{b} and wherein b is from 0 to 0.5; and
X and Z are each independently selected from O, S, F, Cl, Br, I or a mixture thereof.

In some embodiments, the material of formula (II) comprises a mixture of S and O as the Y species. As b is from 0 to 0.5 then up to half of the Y species may be provided by sulphur.

In some embodiments, b is 0 and therefore all Y species are O. The material may therefore have the formula: Li₆₊ₓP₁₋ₓSiₓO₄XZ.

Suitably in such embodiments X is O. Therefore the material may have the formula (III):

Li₆₊ₓP₁₋ₓSiₓO₅Z.

Suitably Z is Cl or Br, or a mixture thereof. Suitably the solid crystalline material has the formula (III):

Li₆₊ₓP₁₋ₓSiₓO₅Z;

wherein 0<x≤1 and Z is Cl or Br, or mixture thereof.

Therefore in such embodiments the solid crystalline material suitably has the formula (IV):

Li₆₊ₓP₁₋ₓSiₓO₅Cl_{1-y}Br_{y}

wherein 0<x≤1 and 0<y≤1.

In some embodiments y is 0. Therefore the solid crystalline material may have the formula (IVa): Li₆₊ₓP₁₋ₓSiₓO₅Cl.

In some embodiments y is 0.5. Therefore the solid crystalline material may have the formula (IVb): Li₆₊ₓP₁₋ₓSiₓO₅Cl_{0.5}Br_{0.5}.

In some embodiments y is 1. Therefore the solid crystalline material may have the formula (IVc): Li₆₊ₓP₁₋ₓSiₓO₅Br.

In one embodiment x is 0.1 and y is 0 and the solid crystalline material of the first aspect has the formula Li_{6.1}P_{0.9}Si_{0.1}O₅Cl.

In one embodiment x is 0.3 and y is 0 and the solid crystalline material of the first aspect has the formula Li_{6.3}P_{0.7}Si_{0.3}O₅Cl.

In one embodiment x is 0.5 and y is 0 and the solid crystalline material of the first aspect has the formula Li_{6.5}P_{0.5}Si_{0.5}O₅Cl.

In one embodiment x is 0.6 and y is 0 and the solid crystalline material of the first aspect has the formula Li_{6.6}P_{0.4}Si_{0.6}O₅Cl.

In one embodiment x is 0.7 and y is 0 and the solid crystalline material of the first aspect has the formula Li_{6.7}P_{0.3}Si_{0.7}O₅Cl.

In one embodiment x is 0.75 and y is 0 and the solid crystalline material of the first aspect has the formula Li_{6.75}P_{0.25}Si_{0.75}O₅Cl.

In one embodiment x is 0.8 and y is 0 and the solid crystalline material of the first aspect has the formula Li_{6.8}P_{0.2}Si_{0.8}O₅Cl.

In one embodiment x is 0.85 and y is 0 and the solid crystalline material of the first aspect has the formula Li_{6.85}P_{0.15}Si_{0.85}O₅Cl.

In one embodiment x is 0.9 and y is 0 and the solid crystalline material of the first aspect has the formula Li_{6.9}P_{0.1}Si_{0.9}O₅Cl.

In one embodiment x is 0.3 and y is 0.5 and the solid crystalline material of the first aspect has the formula Li_{6.3}P_{0.7}Si_{0.3}O₅Cl_{0.5}Br_{0.5}.

In one embodiment x is 0.3 and y is 1 and the solid crystalline material of the first aspect has the formula Li_{6.3}P_{0.7}Si_{0.3}O₅Br.

In one embodiment, x is 0.75 and the solid crystalline material of the first aspect has the formula Li_{6.75}P_{0.25}Si_{0.75}O₅Cl_{0.5}F_{0.5}.

In one embodiment x is 1 and y is 0 and the solid crystalline material of the first aspect has the formula Li₇SiO₅Cl.

The material of this first aspect may be additionally or alternatively defined as a solid crystalline material comprising a solid solution of a solid crystalline material of formula (V): Li₆PY₅X and a solid crystalline material of formula (VI): Li₇SiY₅X, wherein:
each Y is O_{1-b}S_{b}, wherein b is from 0 to 0.5; and
each X is independently selected from F, Cl, Br and I, or mixture thereof.

Suitably the solid crystalline material of formula (V) is Li₆PO₅Cl and the solid crystalline material of formula (VI) is Li₇SiO₅Cl.

The solid crystalline material of this first aspect may comprise the solid crystalline material of formula (V) and the solid crystalline material of formula (VI) in a ratio of from 1:10 to 10:1.

In some embodiments of the solid crystalline material of formula LiₐP₁₋ₓM′ₓY₄XZ, M′ is Ge. Therefore the material of this embodiment suitably has the formula (VII):

Li₆₊ₓP₁₋ₓGeₓY₄XZ;

wherein:
0<x≤1.
Y is O_{1-b}S_{b} and wherein b is from 0 to 0.5; and
X and Z are each independently selected from O, S, F, Cl, Br, I or a mixture thereof.

In some embodiments, the material of formula (VII) comprises a mixture of S and O as the Y species. As b is from 0 to 0.5 then up to half of the Y species may be provided by sulphur.

In some embodiments, b is 0 and therefore all Y species are O. The material may therefore have the formula (VIla): Li₆₊ₓP₁₋ₓGeₓO₄XZ.

Suitably in such embodiments X is O. Therefore the material may have the formula (VIIb):

Li₆₊ₓP₁₋ₓGeₓO₅Z.

Suitably Z is Cl or Br, or a mixture thereof. Suitably the solid crystalline material has the formula (VIIb):

Li₆₊ₓP₁₋ₓGeₓO₅Z;

wherein 0<x≤1 and Z is Cl or Br, or mixture thereof.

Therefore in such embodiments the solid crystalline material suitably has the formula (VIIc):

Li₆₊ₓP₁₋ₓGeₓO₅Cl_{1-y}Br_{y}

wherein 0<x≤1 and 0<y≤1.

In some embodiments y is 0. Therefore the solid crystalline material may have the formula (VIId): Li₆₊ₓP₁₋ₓGeₓO₅Cl.

In one embodiment x is 0.75 and y is 0 and the solid crystalline material of the first aspect has the formula Li_{6.75}P_{0.25}Ge_{0.75}O₅Cl.

In one embodiment x is 1 and y is 0 and the solid crystalline material of the first aspect has the formula Li₇GeO₅Cl.

The solid crystalline material for formula (VII): Li₆₊ₓP₁₋ₓGeₓY₄XZ; may be additionally or alternatively defined as a solid crystalline material comprising a solid solution of a solid crystalline material of formula (V): Li₆PY₅X and a solid crystalline material of formula (VIII): Li₇GeY₅X, wherein:
each Y is O_{1-b}S_{b}, wherein b is from 0 to 0.5; and
each X is independently selected from F, Cl, Br and I, or mixture thereof.

Suitably the solid crystalline material of formula (V) is Li₆PO₅Cl and the solid crystalline material of formula (VIII) is Li₇GeO₅Cl.

The solid crystalline material of this first aspect may comprise the solid crystalline material of formula (V) and the solid crystalline material of formula (VIII) in a ratio of from 1:10 to 10:1.

In some embodiments wherein M is P₁₋ₓM′ₓ; M′ is selected from a mixture of at least two of Si, Al, Sb, Sn, B, Ga and Ge, and 0<x≤1. The material may have the formula: LiₐP₁₋ₓM′ₓY₄XZ.

In such embodiments, a is suitably from 6 to 7. The a value may vary from 6 to 7 according to the amount of the M′ species present. Suitably M′ is a mixture of Si and Ge. Therefore the material of this embodiment suitably has the formula (IX):

Li₆₊ₓP₁₋ₓSiᵥGe_{w}Y₄XZ;

wherein:

$$0 < x \leq 1 ;$$

$$0 < v \leq 1 ;$$

$$0 < w \leq 1 ;$$

$$v + w = x ;$$

Y is O_{1-b}S_{b} and wherein b is from 0 to 0.5; and
X and Z are each independently selected from O, S, F, Cl, Br, I or a mixture thereof.

Suitably 0<v<1. Suitably 0<w<1. Suitably 0<v<1 and 0<w<1, therefore x is suitably <1.

In some embodiments, the material of formula (IX) comprises a mixture of S and O as the Y species. As b is from 0 to 0.5 then up to half of the Y species may be provided by sulphur.

In some embodiments, b is 0 and therefore all Y species are O. The material may therefore have the formula (IXa): Li₆₊ₓP₁₋ₓSiᵥGe_{w}O₄XZ.

Suitably in such embodiments X is O. Therefore the material may have the formula (IXb):

Li₆₊ₓP₁₋ₓSiᵥGe_{w}O₅Z.

Suitably Z is Cl or Br, or a mixture thereof. Suitably the solid crystalline material has the formula (IXb):

Li₆₊ₓP₁₋ₓSiᵥGe_{w}O₅Z;

wherein 0<x≤1 and Z is Cl or Br, or mixture thereof.

Therefore in such embodiments the solid crystalline material suitably has the formula (IXc):

Li₆₊ₓP₁₋ₓSiᵥGe_{w}O₅Cl_{1-y}Br_{y}

wherein 0<x≤1 and 0<y≤1.

In some embodiments y is 0. Therefore the solid crystalline material may have the formula (IXd): Li₆₊ₓP₁₋ₓSiᵥGe_{w}O₅Cl.

In some embodiments y is 0.5. Therefore the solid crystalline material may have the formula (IXe): Li₆₊ₓP₁₋ₓSiᵥGe_{w}O₅Cl_{0.5}Br_{0.5}.

In some embodiments y is 1. Therefore the solid crystalline material may have the formula (IXf): Li₆₊ₓP₁₋ₓSiᵥGe_{w}O₅Br.

In one embodiment x is 0.75, v is 0.375, w is 0.375 and y is 0 and the solid crystalline material of the first aspect has the formula Li_{6.75}P_{0.25}Si_{0.375}Ge_{0.375}O₅Cl.

The material of formula (IX) may be additionally or alternatively defined as a solid crystalline material comprising a solid solution of:
a solid crystalline material of formula (V): Li₆PY₅X;
a solid crystalline material of formula (VI): Li₇SiY₅X; and
a solid crystalline material of formula (VIII): Li₇GeY₅X;
   wherein:
each Y is O_{1-b}S_{b}, wherein b is from 0 to 0.5; and
each X is independently selected from F, Cl, Br and I, or mixture thereof.

Suitably the solid crystalline material of formula (V) is Li₆PO₅Cl; the solid crystalline material of formula (VI) is Li₇SiO₅Cl and the solid crystalline material of formula (VIII) is Li₇GeO₅Cl.

The solid crystalline material of this first aspect may comprise the solid crystalline material of formula (V) and the solid crystalline material of formula (VI) in a ratio of from 1:10 to 10:1.

The solid crystalline material of this first aspect may comprise the solid crystalline material of formula (V) and the solid crystalline material of formula (VIII) in a ratio of from 1:10 to 10:1.

The solid crystalline material of this first aspect may comprise the solid crystalline material of formula (VI) and the solid crystalline material of formula (VIII) in a ratio of from 1:10 to 10:1.

In some embodiments, M is selected from a mixture of at least two of Si, Al, Sb, Sn, B, Ga and Ge. Suitably M is a mixture of Si and Ge. Therefore the material of this embodiment suitably has the formula (X):

Li₇SiᵥGe_{w}Y₄XZ;

wherein:

$$0 < v \leq 1 ;$$

$$0 < w \leq 1 ;$$

$$v + w = 1 ;$$

Y is O_{1-b}S_{b} and wherein b is from 0 to 0.5; and
X and Z are each independently selected from O, S, F, Cl, Br, I or a mixture thereof.

Suitably 0<v<1. Suitably 0<w<1. Suitably 0<v<1 and 0<w<1.

In some embodiments, the material of formula (X) comprises a mixture of S and O as the Y species. As b is from 0 to 0.5 then up to half of the Y species may be provided by sulphur.

In some embodiments, b is 0 and therefore all Y species are O. The material may therefore have the formula (Xa): Li₇SiᵥGe_{w}O₄XZ.

Suitably in such embodiments X is O. Therefore the material may have the formula (Xb):

Li₇SiᵥGe_{w}O₅Z.

Suitably Z is Cl or Br, or a mixture thereof. Suitably the solid crystalline material has the formula (Xb):

Li₇SiᵥGe_{w}O₅Z;
wherein Z is Cl or Br, or mixture thereof.

Therefore in such embodiments the solid crystalline material suitably has the formula (Xc):

Li₇SiᵥGe_{w}O₅Cl_{1-y}Br_{y}

wherein 0<y≤1.

In some embodiments y is 0. Therefore the solid crystalline material may have the formula (Xd): Li₇SiᵥGe_{w}O₅Cl.

In some embodiments y is 0.5. Therefore the solid crystalline material may have the formula (Xe): Li₇SiᵥGe_{w}O₅Cl_{0.5}Br_{0.5}.

In some embodiments y is 1. Therefore the solid crystalline material may have the formula (Xf): Li₇SiᵥGe_{w}O₅Br.

In one embodiment v is 0.5, w is 0.5 and y is 0 and the solid crystalline material of the first aspect has the formula Li₇Si_{0.5}Ge_{0.5}O₅Cl.

The material of formula (X) may be additionally or alternatively defined as a solid crystalline material comprising a solid solution of:
a solid crystalline material of formula (VI): Li₇SiY₅X; and
a solid crystalline material of formula (VIII): Li₇GeY₅X;
   wherein:
each Y is O_{1-b}S_{b}, wherein b is from 0 to 0.5; and
each X is independently selected from F, Cl, Br and I, or mixture thereof.

Suitably the solid crystalline material of formula (VI) is Li₇SiO₅Cl and the solid crystalline material of formula (VIII) is Li₇GeO₅Cl.

The solid crystalline material of this first aspect may comprise the solid crystalline material of formula (VI) and the solid crystalline material of formula (VIII) in a ratio of from 1:10 to 10:1.

Suitably the solid crystalline material is selected from Li₇SiO₅Cl; Li_{6.1}P_{0.9}Si_{0.1}O₅Cl; Li_{6.3}P_{0.7}Si_{0.3}O₅Cl; Li_{6.5}P_{0.5}Si_{0.5}O₅Cl; Li_{6.6}P_{0.4}Si_{0.6}O₅Cl; Li_{6.7}P_{0.3}Si_{0.7}O₅Cl; Li_{6.75}P_{0.25}Si_{0.75}O₅Cl; Li_{6.8}P_{0.2}Si_{0.8}O₅Cl; Li_{6.85}P_{0.15}Si_{0.85}O₅Cl; Li_{6.9}P_{0.1}Si_{0.9}O₅Cl; Li_{6.3}P_{0.7}Si_{0.3}O₅Cl_{0.5}Br_{0.5}; Li_{6.3}P_{0.7}Si_{0.3}O₅Br; Li_{6.75}P_{0.25}Si_{0.75}O₅Cl_{0.5}F_{0.5}; Li_{6.75}P_{0.25}Ge_{0.75}O₅Cl, Li_{6.75}P_{0.25}Si_{0.375}Ge_{0.375}O₅Cl and Li₇GeO₅Cl.

The solid crystalline material of this first aspect is suitably a solid-state lithium ion conductor. The solid crystalline material suitably has a room temperature conductivity of at least 1×10⁻⁷ S cm⁻¹, suitably at least 1×10⁻⁶ S cm⁻¹. The solid crystalline material may have a room temperature conductivity of from 1×10⁻⁷ S cm⁻¹ to 1×10⁻⁴ S cm⁻¹, suitably from 0.5×10⁻⁶ S cm⁻¹ to 2×10⁻⁶ S cm⁻¹. In some embodiments, the solid crystalline material may have a room temperature conductivity of at least 1×10⁻⁵ S cm⁻¹.

According to a second aspect of the present invention, there is provided a solid-state battery comprising:
an anode;
a cathode; and
an electrolyte comprising a solid crystalline material of the first aspect.

The solid crystalline material is a solid-state lithium ion conductor.

Suitably the electrolyte is arranged between the cathode and an anode. Suitably the electrolyte is a solid-state electrolyte. Suitably the solid-state battery is a rechargeable (or “secondary”) battery.

Suitable materials for the cathode and anode may be known in the art.

Suitable constructions of such a solid-state battery are known in the art.

The cathode is suitably a lithium host material capable of storing and releasing lithium ions. For example, the cathode may be a lithium metal oxide wherein the metal is one or more of aluminium, cobalt, iron, manganese, nickel and vanadium. Example lithium metal oxides are LiCoO₂ (LCO), LiFeO₂, LiMnO₂ (LMO), LiMn₂O₄, LiNiO₂ (LNO), LiNiₓCo_{y}O₂, LiMnₓCo_{y}O₂, LiMnₓNi_{y}O₂, LiMnₓNi_{y}O₄, and LiNiₓCo_{y}Al_{z}O₂ amongst others.

Further examples of cathode materials are lithium-containing phosphates having a general formula LiMPO₄ wherein M is one or more of cobalt, iron, manganese, and nickel, such as lithium iron phosphate (LFP) and lithium iron fluorophosphates. Many different elements, e.g. Co, Mn, Ni, Cr, Al, or Li, may be substituted or additionally added into the structure to influence electronic conductivity, ordering of the layer and cycling performance of the cathode materials. The cathode active material can be a mixture of any number of these cathode materials.

Suitable materials for the anode are a lithium host material capable of incorporating and subsequently releasing the lithium ion such as graphite, a lithium metal oxide (e.g. lithium titanium oxide), carbon, a tin/cobalt alloy or silicon/carbon composite material. The anode material can be a mixture of any number of these anode materials. Alternatively, pure Li metal may provide the anode.

### Thin-Film Solid State Batteries

In some embodiments, the solid-state battery of this second aspect is a solid-state thin-film battery. Such solid-state thin-film batteries are typically less than 15 mm thick and may be used in wireless sensors and detectors, medical devices, biosensors, and wearable devices.

Known solid-state thin-film batteries consist of cathodes, formed from oxide-based compounds such as LiCoO₂ and LiMn₂O₄, for example, and anodes of lithium metal or inorganic compounds such as silicon-tin oxynitrides, Sn₃N₄ and Zn₃N₂, or metal films such as Cu in which the anode is formed by lithium plating on the initial charge. The electrolyte in such solid-state thin-film batteries may be provided by a glassy lithium phosphorus oxynitride (‘LiPON’). In general, thin film all solid state batteries (ASSBs) have several advantages when compared to thicker solid electrolyte (SE) based systems. For example, reducing the thickness of the solid electrolyte can improve the gravimetric/volumetric energy density due to the decreased weight/thickness of the cells. Furthermore, the internal resistance decreases when the thickness is reduced therefore enhancing rate performance and power density. This reduced thickness of the solid electrolyte can minimise the cost of ASSBs, which is one of the most important driving factors in the commercialisation of ASSBs.

Solid electrolytes with ionic conductivities around 10⁻⁶ S cm⁻¹ are used in thin film ASSBs. Glassy LiPON is the most widely used thin film solid electrolyte and has a room temperature conductivity of ˜10⁻⁶ S cm⁻¹. The solid crystalline material of the present invention, such as the Li₆₊ₓP₁₋ₓSiₓO₅Cl materials described herein, have similar room temperature conductivities and therefore may be particularly suitable for use as the solid electrolyte in such solid-state thin-film batteries.

Amorphous inorganic solid electrolytes such as glassy LiPON can suffer from compositional inhomogeneity leading to variance in electrochemical properties. The solid crystalline materials of the present invention, for example Li₆₊ₓP₁₋ₓSiₓO₅Cl, are crystalline inorganic electrolytes with narrow composition variation. The cubic high symmetry structure of Li₆₊ₓP₁₋ₓSiₓO₅Cl minimises anisotropic effects on ionic conductivity that can limit other crystalline inorganic materials for use as electrolytes. Therefore these materials may offer improvements compared to amorphous inorganic solid electrolytes such as glassy LiPON in such thin-film solid-state batteries.

### Solid Electrolyte Coatings

In some embodiments of the solid-state battery of this second aspect, the solid crystalline material of the first aspect provides a coating on the solid electrolyte. Suitably the coating is provided between the anode and the solid electrolyte. Suitably the coating is provided between the cathode and the solid electrolyte. Suitably the coating is provided between the anode and the solid electrolyte and between the cathode and the solid electrolyte.

Compared with lithium ion batteries, most ASSBs have higher polarization, lower capacity, and inferior power and cycling capabilities. Some of these issues can be attributed to problems at the interface between electrodes and the electrolyte. Inadequate physical contact, the presence of grain boundaries and chemical or electrochemical reactions all contribute to increased resistance at the cathode-electrolyte, electrolyte-electrolyte and electrolyte-anode interfaces.

Due to the potential chemical incompatibility of some solid electrolytes with cathode and/or anode materials, which is an inherent characteristic specific to the materials, spontaneous chemical reactions can occur at the interfaces, leading to the formation of resistive interphases between the electrodes and the electrolyte, thereby hindering both Li-ion diffusion and charge transfer inside the ASSBs. Applying a conformal and chemically inert coating has proven to be effective at preventing chemical reactions between cathode materials and solid electrolytes, reducing the space charge layer effect, and lowering the interfacial resistance.

Some common coating materials include Li₂SiO₃, Li₄Ti₅O₁₂ (LTO), LiTaO₃, Li₃PO₄ and LiNbO₃, with ionic conductivities ranging from 10⁻⁵ S cm⁻¹ (amorphous LiNbO₃) to 10⁻⁸ S cm⁻¹ (Li₄Ti₅O₁₂). Amorphous LiNbO₃ is a common coating material with an ionic conductivity of 10⁻⁵ S cm⁻¹, much higher than crystalline LiNbO₃ (10⁻¹¹ S cm⁻¹).

The solid crystalline materials of the first aspect suitably have an ionic conductivity higher than most other cathode coating materials; e.g. Li₄Ti₅O₁₂ has an ionic conductivity of ˜10⁻⁸ S cm⁻¹ whereas the conductivities of the materials of the present invention may be at least 1×10⁻⁶ S cm⁻¹. For example, the solid crystalline materials of formula Li₆₊ₓP₁₋ₓSiₓO₅Cl, may have conductivities within the range of 1.2-1.8×10⁻⁶ S cm⁻¹. This higher conductivity, as well as their chemical and mechanical stability, may be advantageous for the use of these materials in such coatings.

Further advantages of the solid crystalline materials of the present invention for these uses are that the materials may be formed by relatively low temperature processes (i.e. 550° C. for 6 hours compared to 800° C. for 16 hours for Li₄Ti₅O₁₂).

Furthermore, particularly in embodiments wherein the material has the formula: Li₆₊ₓP₁₋ₓSiₓO₅Cl, the solid crystalline material of the present invention advantageously consists of elements with high Earth-abundance and therefore may be formed from starting materials which can be readily supplied and which are relatively low cost, compared to known solid electrolyte materials.

According to a third aspect of the present invention, there is provided a method of preparing a solid crystalline material according to the first aspect, the method comprising the steps of:
(a) admixing a source of Li, a source of MYₙ, a source of X, a source of Z and optionally a source of PY₄; wherein n=2 to 4.
(b) heating the mixture obtained in step (a);
wherein M is selected from Si, Al, Sb, Sn, B, Ga and Ge, or a mixture thereof or comprises P₁₋ₓM′x; wherein M′ is selected from Si, Al, Sb, Sn, B, Ga and Ge, or a mixture thereof and wherein 0<x≤1;
wherein when M is Si and at least one of X and Z is O;
Y is O_{1-b}S_{b}, wherein b is from 0 to 0.5; and
X and Z are each independently selected from O, S, F, Cl, Br, I or a mixture thereof.

The method may be a solid state (or dry) procedure, i.e. a method that does not require a solvent.

The solid crystalline material prepared by this third aspect may have any of the suitable features and advantages described above in relation to the first and second aspects.

The solid crystalline material prepared by this third aspect may be used in the solid-state battery of the second aspect.

Suitably the steps of the method of this third aspect are carried out in the order of step (a) followed by step (b).

Step (a) involves admixing a source of Li, a source of MYₙ, a source of X, a source of Z and optionally a source of PY₄.

The source of Li may be any suitable material comprising Li. In some embodiments, Li will also be present in the sources of MYₙ, X, Z and optionally PY₄.

In some embodiments n is 4. The source of MYₙ is therefore suitably a source of MY₄. The source of MYₙ is suitably an oxide. Suitably the source of MYₙ is a silicon oxide. Suitably the source of MYₙ is lithium silicate.

The sources of X and Z suitably comprise lithium.

The sources of X and Z are suitably ionic salts of Li, suitably comprising one or more of F, CI, Br, I, O and S. Therefore the source of X and the source of Z may be selected from LiF, LiCl, LiBr, LiI, Li₂O and Li₂S, and mixtures thereof.

The source of X is suitably Li₂O.

The source of Z is suitably LiCl or LiBr, or a mixture thereof.

In step (a) of the method of this third aspect, a source of PY₄ is optionally added. Suitably the source of PY₄ is Li₃PO₄.

The method of this third aspect may be a solution-based synthetic procedure. However, in preferred embodiments the method of the third aspect is a solid-based synthetic procedure.

Suitably the sources of Li, MYₙ, X, Z and optionally PY₄ are provided as powders. Suitably in step (a) the sources of Li, MYₙ, X, Z and optionally PY₄ are ground together and then heated in step (b).

The sources of Li, MYₙ, X, Z and optionally PY₄ may be ball-milled together.

Suitably, the method of the third aspect involves a step (a1) of drying the sources of Li, MYₙ, X, Z and optionally PY₄, suitably under vacuum, suitably with heating to 150° C. or above. Step (a1) suitably occurs before step (a).

Step (b) involves heating the mixture obtained in step (a). Suitably step (b) involves heating the sources of Li, MYₙ, X, Z and optionally PY₄ to a temperature of from 300 to 1,000° C., suitably to a temperature of from 400 to 700° C. or to a temperature of from 500 to 600° C.

Suitably step (b) involves heating, suitably at said temperatures, the sources of Li, MYₙ, X, Z and optionally PY₄ for at least 30 minutes, suitably for at least 1 hour or at least 2 hours. Suitably step (b) involves heating for up to 15 hours, up to 10 hours or up to 5 hours. For example, the source of the sources of Li, MYₙ, X, Z and optionally PY₄ may be heated to a temperature of from 500 to 600° C. for from 1 to 5 hours. Suitably the heating of step (b) is carried out under vacuum, for example a vacuum having a pressure of from 10⁻⁴ to 10⁻⁶ mbar or approximately 10⁻⁵ mbar.

Prior to the heating of step (b), the mixture obtained in step (a) may be consolidated under pressure, for example into pellets. The mixture obtained in step (a) may be pressed under a pressure of at least 100 MPa, at least 200 MPa or approximately 300 MPa, suitably to consolidate the powder material into pellets.

Suitably the heating of step (b) and the reaction to form the solid crystalline material provides the product as a powder. The product may then be manipulated into the desired format for the uses described herein, suitably using techniques known in the art.

In embodiments wherein the solid crystalline material has the formula (IV): Li₆₊ₓP₁₋ₓSiₓO₅Cl_{1-y}Br_{y} and wherein 0<x≤1 and 0<y≤1; the source of MYₙ is suitably Li₄SiO₄, the source of X is suitably Li₂O, the source of Z is suitably LiCl and LiBr, the source of PY₄ is present and is suitably Li₃PO₄, and the source of Li is suitably provided by each of the aforementioned materials. In such embodiments, step (a) suitably comprises admixing Li₄SiO₄, Li₃PO₄, Li₂O, LiCl and LiBr in the required stoichiometric ratios to produce the desired material, i.e. the desired value of x.

Li₄SiO₄ may be prepared using any suitable method. For example, by reacting Li₂CO₃ and SiO₂ in a 2:1 ratio.

Using this method of the third aspect, the materials of the first aspect may be prepared at a lower synthesis temperature than conventional materials used as solid-state electrolytes in solid-state batteries. The synthesis of the materials according to this third aspect may be simpler than the synthesis of such conventional solid-state materials.

Moreover the method of this third aspect may utilise only elements with a high Earth-abundance.

According to a fourth aspect of the present invention, there is provided the use of a solid crystalline material according to the first aspect as a solid-state conductor.

The solid crystalline material of the first aspect may be used as a lithium ion electrolyte in primary and secondary electrochemical energy stores.

In this fourth aspect, the solid crystalline material is suitably used as a solid electrolyte, for example in a solid-state lithium-ion battery.

In some embodiments, the solid crystalline material may be used as a coating for an electrode of a solid-state battery, as described above in relation to the second aspect. In some embodiments, the solid crystalline material may be used as a coating of an electrode in a conventional lithium-ion battery.

The solid crystalline material used in this fourth aspect may have any of the suitable features and advantages described in relation to the first aspect. For example, the solid crystalline material used in this fourth aspect may provide high ionic conductivity whilst also having mechanical properties (such as bulk modulus and shear modulus) which facilitate processing and manufacture. The use of such solid crystalline materials of the first aspect may therefore provide an advantageous solid-state conductor for use as a solid-state electrolyte in batteries.

### EXAMPLES—SYNTHESIS

### Materials

Li₂CO₃ (99.99%), SiO₂ (silica gel, high purity grade), Li₃PO₄ (99.5%) LiCl (ultra dry, 99.995%) and LiBr (ultra dry, 99.995%) were purchased from Sigma Aldrich and Li₂O (99.5%) was purchased from Alfa Aesar.

Synthesis of Li₄SiO₄

Precursors were dried overnight in a 200° C. furnace before use. Li₂CO₃ (1.2331 g) and SiO₂ (0.5013 g) were weighed according to the stoichiometric 2:1 ratio. The powders were ground in an agate mortar for 15 minutes, placed into an alumina crucible and heated in air to 800° C. at a ramp rate of 5° C./min, held at 800° C. for 10 hours and cooled at a ramp rate of 5° C./min. The resulting product was ground in an agate mortar to obtain a fine powder, which was then used as a precursor in the final synthesis step.

Synthesis of Li₆₊ₓP₁₋ₓSiₓO₅Cl_{1-y}Br_{y} (x=0.1, 0.3, 0.5, 0.6, 0.7, 0.75, 0.8, 0.85, 0.9 when y=0; x=0.3 when y=0.5 or 1)

Li₄SiO₄, Li₃PO₄, Li₂O, LiCl and LiBr were vacuum dried (under 10⁻⁴ mbar) at 200° C. (Li₄SiO₄, LiCl), 300° C. (LiBr), 400° C. (Li₃PO₄) and 950° C. (Li₂O) overnight before placing them in an Ar-filled glove box. All precursors and resulting powders were then handled in an Ar-filled glove box (O₂<0.1 ppm, H₂O<1 ppm). Li₄SiO₄, Li₃PO₄, Li₂O, LiCl and/or LiBr and were mixed in the stoichiometric ratios using ball milling. The precursors were ball milled in 1 g batches for a total time of 6 h (intervals: 20 min on, 10 min off) in 45 mL zirconia jars using 7 zirconia balls (diameter: 10 mm). The resulting powder was then pressed into 5 mm diameter pellets using 300 MPa pressure. The pellets were placed into alumina crucibles and the crucibles were placed in flame dried quartz tubes which were sealed under vacuum (˜10⁻⁵ mbar). The tubes were heated to 525-550° C. at a ramp rate of 5° C./min, held at 525-550° C. for 3 h and cooled at a rate of 5° C./min. The quartz tubes were opened inside the Ar glovebox, and the powder ground in a pestle and mortar for further characterisation (XRD). For AC impedance analysis the annealed pellets were used for measurements directly (reactive sintering).

Synthesis of Li₆PO₅Cl

Li₆PO₅Cl was synthesized starting from stoichiometric amounts of Li₃PO₄, Li₂O and LiCl. The starting materials were homogenized, pressed to pellets and transferred into a gold crucible, which was placed in a quartz ampoule. A reaction in carbon coated quartz glass ampoules results in less homogeneous products. All experiments were carried out in an argon-filled glovebox (O₂<1 ppm, H₂O<1 ppm) and the starting materials and hardware (mortar, pressing tool, ampoules etc.) were carefully dried at T˜593 K-720 K (ampoules). The evacuated quartz glass ampoules were annealed for 120 h at 723 K. After the reaction, the ampoules were slowly cooled to room temperature. The colourless and hygroscopic products were handled in a glovebox.

Synthesis of Li_{6.3}P_{0.7}Si_{0.3}O₅Cl

Li₄SiO₄, Li₃PO₄, Li₂O and LiCl were vacuum dried (under 10⁻⁴ mbar) at 200° C. (Li₄SiO₄, LiCl), 400° C. (Li₃PO₄) and 950° C. (Li₂O) overnight before placing them in an Ar-filled glove box. All precursors and resulting powders were then handled in an Ar-filled glove box (O₂<0.1 ppm, H₂O<1 ppm). Li₄SiO₄ (0.1899 g), Li₃PO₄ (0.4282 g), Li₂O (0.1579 g) and LiCl (0.2240 g) were mixed using ball milling. The precursors were ball milled for a total time of 6 h (intervals: 20 min on, 10 min off) in 45 mL zirconia jars using 7 zirconia balls (diameter: 10 mm). The resulting powder was then pressed into 5 mm diameter pellets using 300 MPa pressure. The pellets were placed into alumina crucibles and the crucibles were placed in flame dried quartz tubes which were sealed under vacuum (˜10⁻⁵ mbar). The tubes were heated to 550° C. at a ramp rate of 5° C./min, held at 550° C. for 3 h and cooled at a rate of 5° C./min. The quartz tubes were opened inside the Ar glovebox, and the powder ground in a pestle and mortar for further characterisation (XRD). For AC impedance analysis the annealed pellets were used for measurements directly (reactive sintering).

Synthesis of Li_{6.5}P_{0.5}Si_{0.5}O₅Cl

Li₄SiO₄, Li₃PO₄, Li₂O and LiCl were vacuum dried (under 10⁻⁴ mbar) at 200° C. (Li₄SiO₄, LiCl), 400° C. (Li₃PO₄) and 950° C. (Li₂O) overnight before placing them in an Ar-filled glove box (O₂<0.1 ppm, H₂O<1 ppm). All precursors and resulting powders were then handled in an Ar-filled glove box. Li₄SiO₄ (0.3152 g), Li₃PO₄ (0.3046 g), Li₂O (0.1572 g) and LiCl (0.2230 g) were mixed using ball milling. The precursors were ball milled for a total time of 6 h (intervals: 20 min on, 10 min off) in 45 mL zirconia jars using 7 zirconia balls (diameter: 10 mm). The resulting powder was then pressed into 5 mm diameter pellets using 300 MPa pressure. The pellets were placed into alumina crucibles and the crucibles were placed in flame dried quartz tubes which were sealed under vacuum (˜10⁻⁵ mbar). The tubes were heated to 550° C. at a ramp rate of 5° C./min, held at 550° C. for 3 h and cooled at a rate of 5° C./min. The quartz tubes were opened inside the Ar glovebox, and the powder ground in a pestle and mortar for further characterisation (XRD). For AC impedance analysis the annealed pellets were used for measurements directly (reactive sintering).

Synthesis of Li_{6.7}P_{0.3}Si_{0.7}O₅Cl

Li₄SiO₄, Li₃PO₄, Li₂O and LiCl were vacuum dried (under 10⁻⁴ mbar) at 200° C. (Li₄SiO₄, LiCl), 400° C. (Li₃PO₄) and 950° C. (Li₂O) overnight before placing them in an Ar-filled glove box (O₂<0.1 ppm, H₂O<1 ppm). All precursors and resulting powders were then handled in an Ar-filled glove box. Li₄SiO₄ (0.4394 g), Li₃PO₄ (0.1820 g), Li₂O (0.1565 g) and LiCl (0.2221 g) were mixed using ball milling. The precursors were ball milled for a total time of 6 h (intervals: 20 min on, 10 min off) in 45 mL zirconia jars using 7 zirconia balls (diameter: 10 mm). The resulting powder was then pressed into 5 mm diameter pellets using 300 MPa pressure. The pellets were placed into alumina crucibles and the crucibles were placed in flame dried quartz tubes which were sealed under vacuum (˜10⁻⁵ mbar). The tubes were heated to 550° C. at a ramp rate of 5° C./min, held at 550° C. for 3 h and cooled at a rate of 5° C./min. The quartz tubes were opened inside the Ar glovebox, and the powder ground in a pestle and mortar for further characterisation (XRD). For AC impedance analysis the annealed pellets were used for measurements directly (reactive sintering).

Synthesis of Li₇SiO₅Cl

Li₄SiO₄, Li₂O and LiCl were vacuum dried (under 10⁻⁴ mbar) at 200° C. (Li₄SiO₄, LiCl) and 950° C. (Li₂O) overnight before placing them in an Ar-filled glove box (O₂<0.1 ppm, H₂O<1 ppm). All precursors and resulting powders were then handled in an Ar-filled glove box. Li₄SiO₄ (0.6238 g), Li₂O (0.1555 g) and LiCl (0.2207 g) were mixed using ball milling. The precursors were ball milled for a total time of 6 h (intervals: 20 min on, 10 min off) in 45 mL zirconia jars using 7 zirconia balls (diameter: 10 mm). The resulting powder was then pressed into 5 mm diameter pellets using 300 MPa pressure. The pellets were placed into alumina crucibles and the crucibles were placed in flame dried quartz tubes which were sealed under vacuum (˜10⁻⁵ mbar). The tubes were heated to 600° C. at a ramp rate of 5° C./min, held at 600° C. for 3 h and cooled at a rate of 5° C./min. The quartz tubes were opened inside the Ar glovebox, and the powder ground in a pestle and mortar for further characterisation (XRD).

Synthesis of Li_{6.3}P_{0.7}Si_{0.3}O₅Cl_{0.5}Br_{0.5}

Li₄SiO₄, Li₃PO₄, Li₂O, LiCl and LiBr were vacuum dried (under 10⁻⁴ mbar) at 200° C. (Li₄SiO₄, LiCl), 300° C. (LiBr), 400° C. (Li₃PO₄) and 950° C. (Li₂O) overnight before placing them in an Ar-filled glove box (O₂<0.1 ppm, H₂O<1 ppm). All precursors and resulting powders were then handled in an Ar-filled glove box. Li₄SiO₄ (0.1700 g), Li₃PO₄ (0.3832 g), Li₂O (0.1413 g) LiCl (0.1002 g) and LiBr (0.2053 g) were mixed using ball milling. The precursors were ball milled for a total time of 6 h (intervals: 20 min on, 10 min off) in 45 mL zirconia jars using 7 zirconia balls (diameter: 10 mm). The resulting powder was then pressed into 5 mm diameter pellets using 300 MPa pressure. The pellets were placed into alumina crucibles and the crucibles were placed in flame dried quartz tubes which were sealed under vacuum (˜10.5 mbar). The tubes were heated to 525° C. at a ramp rate of 5° C./min, held at 525° C. for 3 h and cooled at a rate of 5° C./min. The quartz tubes were opened inside the Ar glovebox, and the powder ground in a pestle and mortar for further characterisation (XRD).

Synthesis of Li_{6.3}P_{0.7}Si_{0.3}O₅Br

Li₄SiO₄, Li₃PO₄, Li₂O and LiBr were vacuum dried (under 10⁻⁴ mbar) at 200° C. (Li₄SiO₄), 300° C. (LiBr), 400° C. (Li₃PO₄) and 950° C. (Li₂O) overnight before placing them in an Ar-filled glove box (O₂<0.1 ppm, H₂O<1 ppm). All precursors and resulting powders were then handled in an Ar-filled glove box. Li₄SiO₄ (0.1538 g), Li₃PO₄ (0.3468 g), Li₂O (0.1278 g) and LiBr (0.3716 g) were mixed using ball milling. The precursors were ball milled for a total time of 6 h (intervals: 20 min on, 10 min off) in 45 mL zirconia jars using 7 zirconia balls (diameter: 10 mm). The resulting powder was then pressed into 5 mm diameter pellets using 300 MPa pressure. The pellets were placed into alumina crucibles and the crucibles were placed in flame dried quartz tubes which were sealed under vacuum (˜10⁻⁵ mbar). The tubes were heated to 550° C. at a ramp rate of 5° C./min, held at 550° C. for 3 h and cooled at a rate of 5° C./min. The quartz tubes were opened inside the Ar glovebox, and the powder ground in a pestle and mortar for further characterisation (XRD).

### Densification by Spark Plasma Sintering (SPS)

Dense pellets of Li₆₊ₓP₁₋ₓSiₓO₅Cl (x=0.7, 0.75 and 0.8) were prepared via spark plasma sintering (SPS) using a commercial Thermal Technology LLC DCS10 furnace. For each pellet, ˜0.3 g of powder was loaded into a 10 mm inner diameter tungsten carbide die set (WC with 6% Co binder) lined with graphite foil inside an Ar-filled drybox (O₂<0.1 ppm, H₂O<0.1 ppm). Vacuum grease was applied to the punches to form a temporary air-tight seal as the die was transferred into the SPS furnace chamber which was then evacuated to <5×10⁻² mbar. 800 MPa of uniaxial pressure was applied to the powders at a rate of 100 MPa min⁻¹. Samples were heated to 455° C. at a rate of 50° C. min⁻¹, annealed for 30 seconds, before the applied current was turned off and the die set allowed to cool to room temperature, and the pressure released at a rate of 100 MPa min⁻¹. The temperature was monitored through a borehole in the side of the die via a pyrometer. The temperature of the sample would typically overshoot by 10-15° C. during this procedure. Once at room temperature, the die set was transferred to the drybox, the pellets were removed, and the graphite foil on the pellet surface was removed by lightly polishing with SiC polishing paper. This procedure resulted in pellets with densities of 94-96% relative to the theoretical densities.

### EXAMPLES—POWDER X-RAY DIFFRACTION

Powder X-ray Diffraction (XRD) data were collected using a Bruker D8 Discover diffractometer with monochromatic Cu radiation (Kα₁, λ=1.54056 Å) in Debye Scherrer transmission geometry with sample powders loaded into 0.7 mm borosilicate glass capillaries.

The cubic argyrodite phase Li₆₊ₓP₁₋ₓSiₓO₅Cl_{1-y}Br_{y} (x=0.1, 0.3, 0.5, 0.6, 0.7, 0.75, 0.8, 0.85, 0.9 for y=0, x=0.3 for y=0.5, 1) was present in all samples.

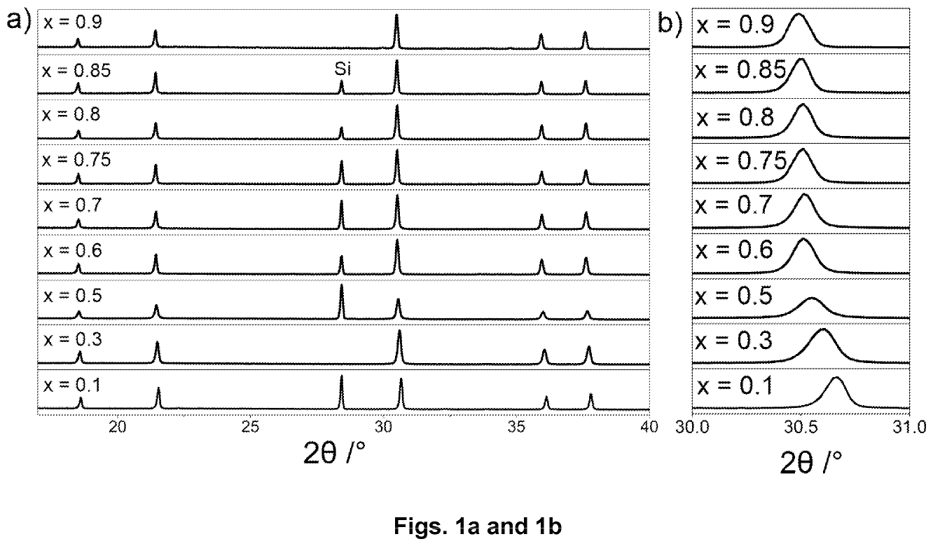

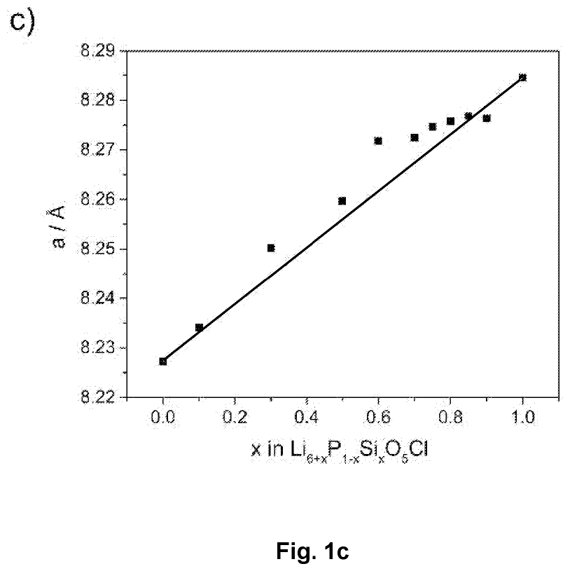

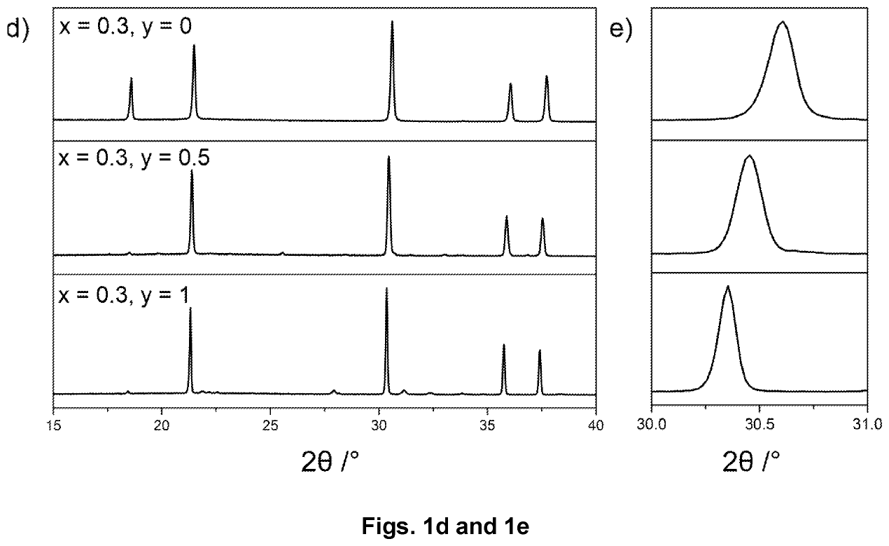

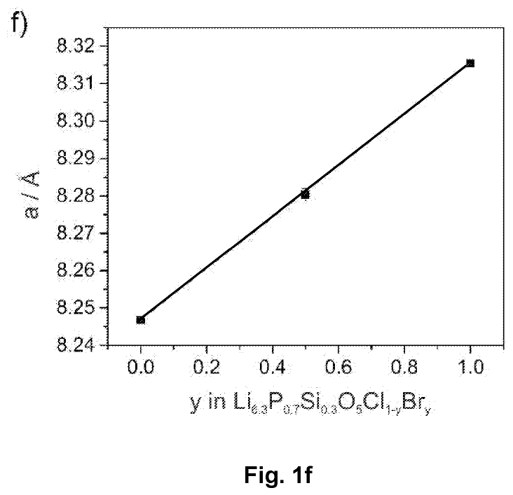

The lattice parameters were extracted (for y=0) and found to increase with increasing value of x (i.e., increasing amount of lithium and silicon) consistent with an increase in unit cell size due to the incorporation of larger Si (r_{Si(IV)}: 0.26 Å, r_{P(V)}: 0.17 Å) and more lithium atoms therefore confirming the successful incorporation of Si into the material. (FIG. 1a-c).

An increase in lattice parameters was observed when comparing equal values of x (i.e., x=0.3) with different values of y (i.e., y=0, 0.5, 1) confirming the successful incorporation of the larger Br ion (r_{Cl}: 1.81 Å, r_{Br}: 1.96 Å) into the lattice (FIG. 1d-f).

FIG. 1a shows the Powder XRD patterns for Li₆₊ₓP₁₋ₓSiₓO₅Cl (x=0.1, 0.3, 0.5, 0.6, 0.7, 0.75, 0.8, 0.85, 0.9), confirming the presence of the cubic argyrodite phase for all compositions (internal standard peaks labelled as Si are also present).

FIG. 1b focuses on cubic argyrodite peak around 30° to highlight peak shift to lower 2θ values with increasing value of x.

FIG. 1c shows lattice parameters as a function of x extracted form Pawley fits, lattice parameters increase with increasing amount of Si until they start plateau at x=0.85 and x=0.9.

FIG. 1d shows Powder XRD patterns for Li_{6.3}P_{0.7}Si_{0.3}O₅Cl_{1-y}Br_{y} (y=0, 0.5, 1) confirming the presence of the cubic argyrodite phase for all compositions

FIG. 1e focuses on cubic argyrodite peak around 30° to highlight peak shift to lower 2θ values with increasing value of y.

FIG. 1f shows lattice parameters as a function of y extracted form Pawley fits, lattice parameters increase with increasing amount of Br.

### EXAMPLES—AC IMPEDANCE SPECTROSCOPY

Pellets of Li₆₊ₓP₁₋ₓSiₓO₅Cl (x=0.1, 0.3, 0.5, 0.6, 0.7, 0.8, 0.85, 0.9) were prepared by uniaxially pressing ˜30 mg of starting material in an 5 mm cylindrical steel dye at a pressure of 300 MPa.

The pellets were annealed in an evacuated, flame dried quartz tube for 3 h at 550° C. Using this method, a relative density of 77-81% was achieved. Pellets of Li₆₊ₓP₁₋ₓSiₓO₅Cl (x=0.7, 0.75, 0.8) were prepared by spark plasma sintering (SPS). Using SPS a relative density of 94-96% was achieved.

AC impedance measurements were conducted using an impedance analyser (Keysight impedance analyser E4990A). A sputtered gold coating of ˜300 nm thickness was used as the ion blocking electrodes. Sputtering was achieved using the sputter coater Q150R. Temperature dependent conductivity measurements were performed under argon in a frequency range of 2 MHz-20 Hz (with an amplitude of 1 mV). Measurements were performed at room temperature and in the temperature range 50-150° C. in 25° C. steps. The ZView2 program was used to fit the impedance spectra with an equivalent circuit.

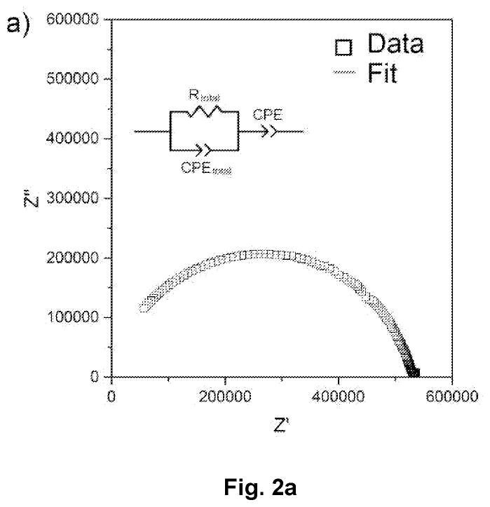

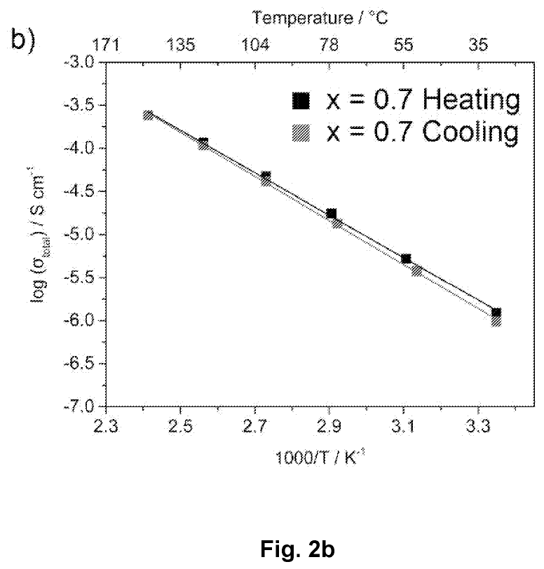

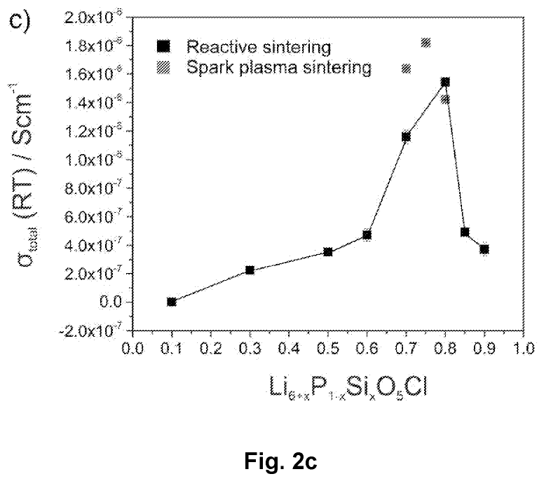

A typical Nyquist plot measured at 30° C. can be seen in the inset in FIG. 2a for sample Li_{6.7}P_{0.3}Si_{0.7}O₅Cl. The plot shows one semicircle corresponding to the total impedance of the sample; grain boundary contributions and bulk contribution could not be separated. The capacity values are in the order of ˜10⁻¹² F which fits well with characteristic bulk response values. The high-frequency intercept of the semicircle gives direct values of the total resistance. The material shows a total ionic conductivity of 1.2×10⁻⁶ Scm⁻¹ at 30° C.

FIG. 2b shows the Arrhenius plot extracted from variable temperature impedance measurements for Li_{6.7}P_{0.3}Si_{0.7}O₅Cl. The impedance of the material was measured over the temperature range 25-150° C. The total conductivity at each temperature was extracted and shown to follow the Arrhenius law. The activation energy was found to be 0.45(2) eV,

FIG. 2c shows the room temperature total conductivity as a function of x. Pellets prepared by reactive sintering are shown as black square and pellets prepared by SPS are shown as grey squares. The conductivity increases by 2 orders of magnitude from ˜10⁻⁹ Scm⁻¹ to ˜10⁻⁷ S cm⁻¹ when increasing the value of x from 0.1 to 0.3, it then increases with x until it reaches a maximum of 1.8×10⁻⁶ S cm⁻¹ at x=0.75 before it decreases again when the value of x is increased further (˜5×10⁻⁷ for x=0.9).

### EXAMPLES—STABILITY IN AIR

Air stability of the oxide argyrodite Li_{6.7}P_{0.3}Si_{0.7}O₅Cl of the present invention was tested and compared to the sulphide argyrodite Li₆PS₅Cl. Powder X-Ray diffraction (PXRD) data were collected for pristine samples using a Bruker D8 Discover diffractometer with monochromatic Cu radiation (Kα₁, λ=1.54056 Å) in Debye Scherrer transmission geometry with sample powders loaded into 0.7 mm and 0.5 mm borosilicate glass capillaries for Li_{6.7}P_{0.3}Si_{0.7}O₅Cl and Li₆PS₅Cl respectively. To test the stability in air, PXRD data were collected using a Panalytical X'pert Pro instrument with Co Kα₁ (λ=1.788960 Å) radiation Data were collected continuously in 30-minute scans over a period of 12 h and then in 6 h intervals over a period of 60 h for Li_{6.7}P_{0.3}Si_{0.7}O₅Cl. Two 30-minute scans over a period of 1 h for Li₆PS₅Cl were collected.

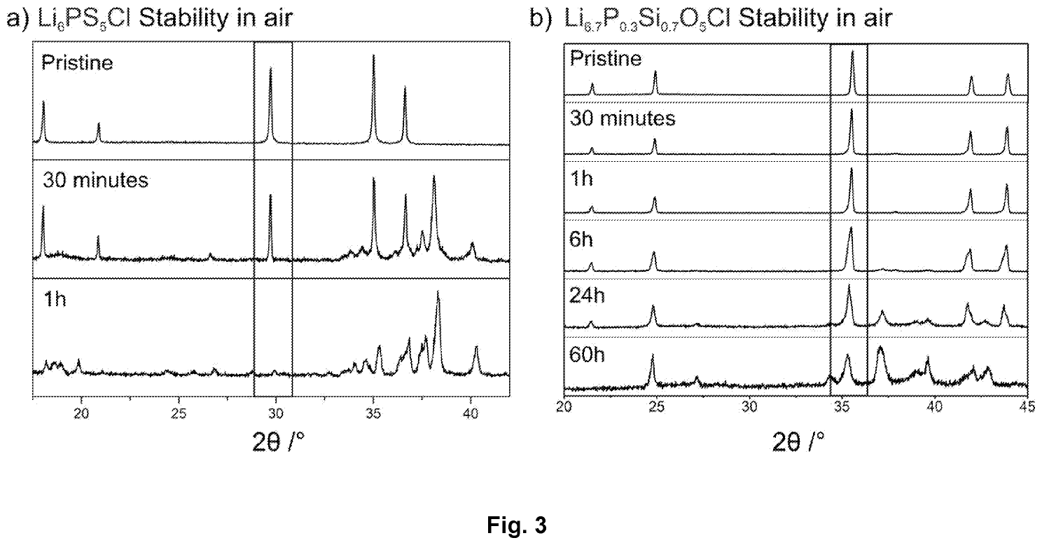

FIG. 3 shows a comparison between the air stability of Li₆PS₅Cl (comparative example) and the oxide argyrodite Li_{6.7}P_{0.3}Si_{0.7}O₅Cl (of the present invention). As can be seen in FIG. 3a the peaks corresponding to the cubic argyrodite phase Li₆PS₅Cl have disappeared after being exposed to air for a total of 1 h, and the intensity of peaks from impurities is significant even after 30 minutes. In contrast, the oxide argyrodite shows increased stability in air (FIG. 3b). The material is still almost pure after 1 h and still the predominant phase after 24 hours. Broadening of the highlighted argyrodite peaks and the increase in intensity of impurity phase peaks suggest slow decomposition over a longer timescale relative to Li₆PS₅Cl. The main cubic argyrodite peaks are still present after 60 h but are significantly broadened and the intensity of peaks corresponding to impurity phases has increased significantly.

### EXAMPLES—STABILITY AGAINST LITHIUM METAL

A pellet of the oxide argyrodite Li_{6.75}P_{0.25}Si_{0.75}O₅Cl of the present invention was synthesised via spark plasma sintering. Symmetric Li|Li_{6.75}P_{0.25}Si_{0.75}O₅Cl|Li cells were assembled inside an Ar-filled glovebox (O₂, H₂O≤0.1 ppm). The thickness of the Li_{6.75}P_{0.25}Si_{0.75}O₅Cl pellet was ˜0.9 mm. Two discs of Li (99.9%, 0.38 mm thickness, Sigma-Aldrich) were pressed onto steel discs. The steel/Li|Li_{6.75}P_{0.25}Si_{0.75}O₅Cl|Li/steel stack was carefully aligned, compressed, and sealed inside a two-electrode coin cell. The Li_{6.75}P_{0.25}Si_{0.75}O₅Cl/Li interface stability was evaluated by the galvanostatic Li plating/stripping tests, which were performed at 298 K at a current density of 20 μA cm⁻² (20 min per half-cycle) using a BioLogic VSP 300 potentiostat.

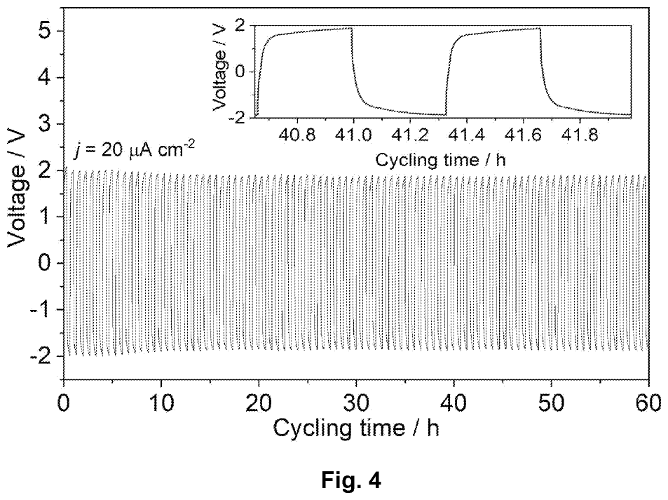

The results are shown in FIG. 4. The steady operation of galvanostatic Li plating/stripping over 60 h in a Li|Li_{6.75}P_{0.25}Si_{0.75}O₅Cl|Li symmetric cell confirms the back-and-forth Lit transport through the Li_{6.75}P_{0.25}Si_{0.75}O₅Cl solid electrolyte and the solid electrolyte/Li interface, and good chemical compatibility between the solid electrolyte and Li metal.

These results demonstrate that the solid crystalline materials of the present invention have advantageous conductivities and physical characteristics for use in solid-state batteries.

### FURTHER EXAMPLES—SYNTHESIS

### Materials

Li₂CO₃ (99.99%), SiO₂ (silica gel, high purity grade), Li₃PO₄ (99.5%) and LiCl (ultra-dry, 99.995%) were purchased from Sigma Aldrich and Li₂O (99.5%), GeO₂ (99.99%) and LiF (ultra-dry, 99.99%) were purchased from Alfa Aesar.

Synthesis of Li₄SiO₄ and Li₄GeO₄

Precursors were dried overnight in a 200° C. furnace before use. Li₂CO₃ and SiO₂ (Li₄SiO₄) or GeO₂ (Li₄GeO₄) were weighed according to the stoichiometric 2:1 ratio. The powders were ground in an agate mortar for 15 minutes, placed into an alumina crucible and heated in air to 800° C. at a ramp rate of 5° C./min, held at 800° C. for 10 hours and cooled at a ramp rate of 5° C./min. The resulting product was ground in an agate mortar to obtain a fine powder, which was then used as a precursor in the final synthesis step.

Synthesis of Li_{6.75}P_{0.25}Si_{0.75-w}Ge_{w}O₅Cl (w=0.375 and 0.75), Li₇GeO₅Cl and Li_{6.75}P_{0.25}Si_{0.75}O₅Cl_{0.5}F_{0.5}

The precursors Li₄SiO₄, Li₄GeO₄, Li₃PO₄, Li₂O, LiF and LiCl were vacuum dried (under 10⁻⁴ mbar) at 200° C. (Li₄SiO₄, Li₄GeO₄, LiCl), 400° C. (Li₃PO₄, LiF) and 950° C. (Li₂O) overnight before placing them in an Ar-filled glove box. All precursors and resulting powders were then handled in an Ar-filled glove box. The corresponding precursors were mixed in the stoichiometric ratios using ball milling. The precursors were ball milled in 1 g batches for a total time of 6 h (intervals: 20 min on, 10 min off) in 45 mL zirconia jars using 7 zirconia balls (diameter: 10 mm). The resulting powder was then pressed into 5 mm diameter pellets using 300 MPa pressure. The pellets were placed into alumina crucibles and the crucibles were placed in flame dried quartz tubes which were sealed under vacuum (˜10⁻⁵ mbar). The tubes were heated to 550° C. at a ramp rate 5° C./min, held at 550° C. for 3 h and cooled at a rate of 5° C./min. The quartz tubes were opened inside the Ar glovebox, and the powder ground in a pestle and mortar for further characterisation (XRD). For AC impedance analysis the annealed pellets were used for measurements directly.

This procedure was used to obtain the following materials:
Li_{6.75}P_{0.25}Si_{0.375}Ge_{0.375}O₅Cl,
Li_{6.75}P_{0.25}Ge_{0.75}O₅Cl,
Li₇GeO₅Cl and
Li_{6.75}P_{0.25}Si_{0.75}O₅Cl_{0.5}F_{0.5}

### FURTHER EXAMPLES—POWDER X-RAY DIFFRACTION

Powder X-ray Diffraction (XRD) data was collected using a Bruker D8 Discover diffractometer with monochromatic Cu radiation (Kα₁, λ=1.54056 Å) in Debye Scherrer transmission geometry with sample powders loaded into 0.3-0.7 mm borosilicate glass capillaries.

### FURTHER EXAMPLES—AC IMPEDANCE SPECTROSCOPY

Pellets of Li_{6.75}P_{0.25}Si_{0.375}Ge_{0.375}O₅Cl were prepared by uniaxially pressing ˜30 mg of starting material in an 5 mm cylindrical steel dye at a pressure of 300 MPa. The pellets were annealed in an evacuated, flame dried quartz tube for 3 h at 550° C. Using this method, a relative density of 77-81% was achieved.

AC impedance measurements were conducted using an impedance analyser (Keysight impedance analyser E4990A). A sputtered gold coating of ˜300 nm thickness was used as the ion blocking electrodes. Sputtering was achieved using the sputter coater Q150R. Temperature dependent conductivity measurements were performed under argon in a frequency range of 2 MHz-20 Hz (with an amplitude of 1 mV). Measurements were performed at room temperature.

Li_{6.75}P_{0.25}Si_{0.75w}Ge_{w}O₅Cl (w=0.375, 0.75)

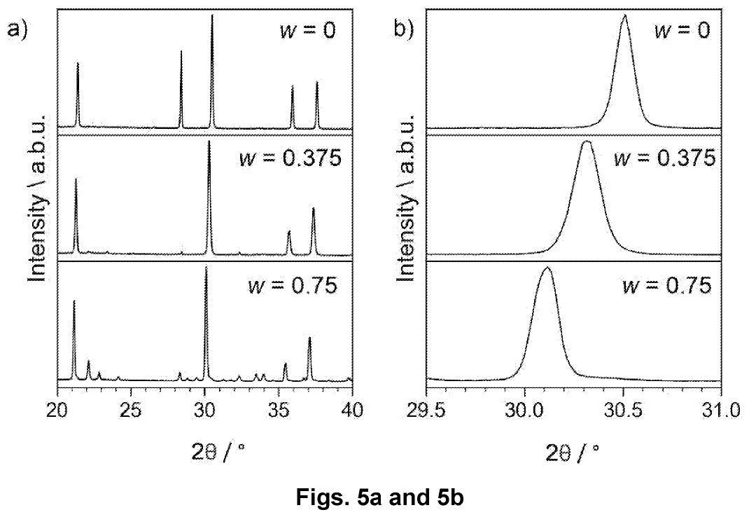

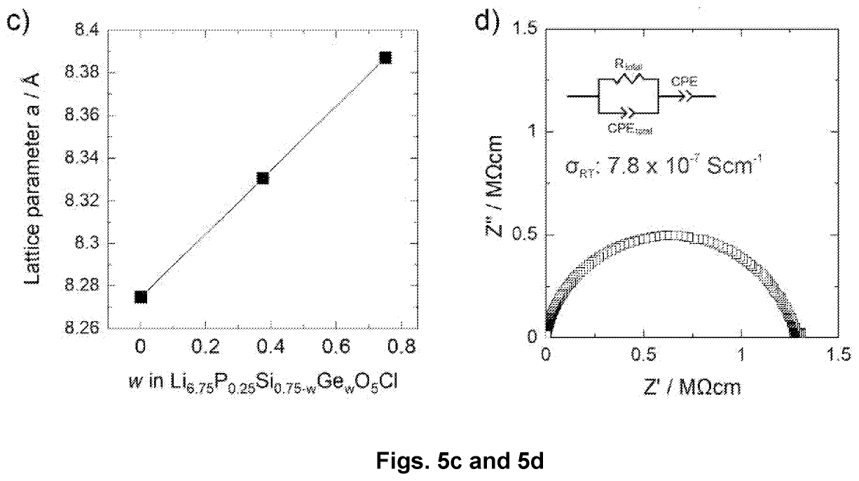

XRD patterns were collected for Li_{6.75}P_{0.25}Si_{0.75-w}Ge_{w}O₅Cl (w=0.375, 0.75) and the cubic argyrodite phase was present in all samples. The lattice parameters were extracted and found to increase with increasing value of w (i.e., increasing amount of germanium) consistent with an increase in unit cell size due to the incorporation of larger Ge (r_{Si(iv)}: 0.26 Å, r_{Ge(V)}: 0.39 Å) therefore confirming the successful incorporation of Ge into the material. FIG. 5 shows a) Powder XRD patterns for Li_{6.75}P_{0.25}Si_{0.75-w}Ge_{w}O₅Cl (w=0, 0.375, 0.75), confirming the presence of the cubic argyrodite phase for all compositions; b) focusing on cubic argyrodite peak around 30° to highlight peak shift to lower 2θ values with increasing value of w; c) lattice parameters as a function of w extracted form Pawley fits, lattice parameters increase with increasing amount of Ge.

Room temperature AC impedance data were collected for a pellet of Li_{6.75}P_{0.25}Si_{0.375}Ge_{0.375}O₅Cl. The Nyquist plot measured at room temperature can be seen in FIG. 5d. FIG. 5d shows impedance complex plane plots Z* of Li_{6.75}P_{0.25}Si_{0.375}Ge_{0.375}O₅Cl at 298 K, inset shows equivalent circuit used to model the data. The plot shows one semicircle corresponding to the total impedance of the sample; grain boundary contributions and bulk contribution could not be separated. The capacity values are in the order of ˜10⁻¹² F which fits well with characteristic bulk response values. The high-frequency intercept of the semicircle gives direct values of the total resistance. The material shows a total ionic conductivity of 7.8×10⁻⁷ Scm⁻¹.

Li₇GeO₅Cl

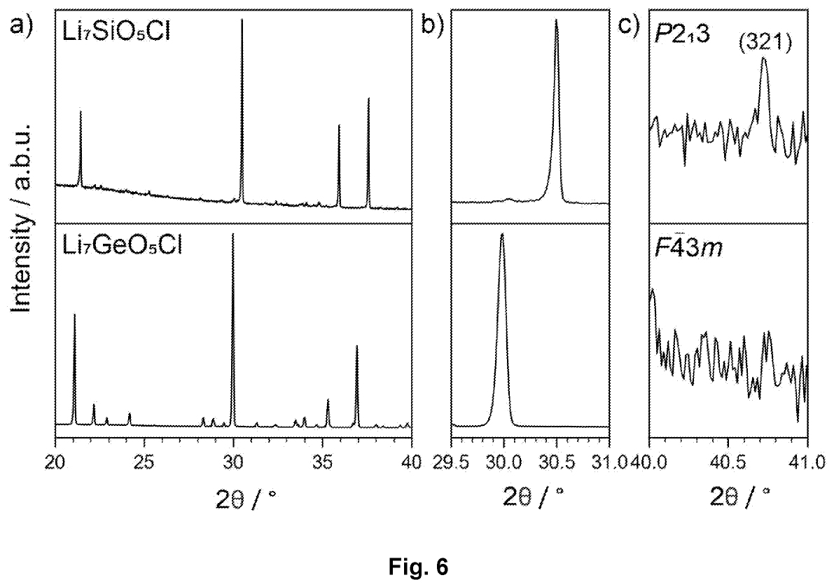

XRD patterns were collected for Li₇GeO₅Cl and the cubic argyrodite phase was present in the sample. A peak shift to lower 2θ values confirms the successful incorporation of the larger Ge into the lattice (r_{Si(IV)}: 0.26 Å, r_{Ge(V)}: 0.39 Å). FIG. 6 shows a) Powder XRD patterns for Li₇SiO₅Cl and Li₇GeO₅Cl confirming the presence of the cubic argyrodite phase b) focusing on cubic argyrodite peak around 30° to highlight peak shift to lower 2θ values for the Germanium analogue; and c) focusing on the (321) reflection which can be seen in Li₇SiO₅Cl confirming it crystallises with P2₁3 symmetry whilst the reflection is absent in Li₇GeO₅Cl crystallising in F4̅3m. The silicate Li₇SiO₅Cl crystallizes in the P2₁3 space group whilst Li₇GeO₅Cl is found to crystallize in the F4̅3m space group as confirmed by the absence of reflections characteristic of P2₁3 symmetry (i.e., (321)).

Li_{6.75}P_{0.25}Si_{0.75}O₅Cl_{0.5}F_{0.5}

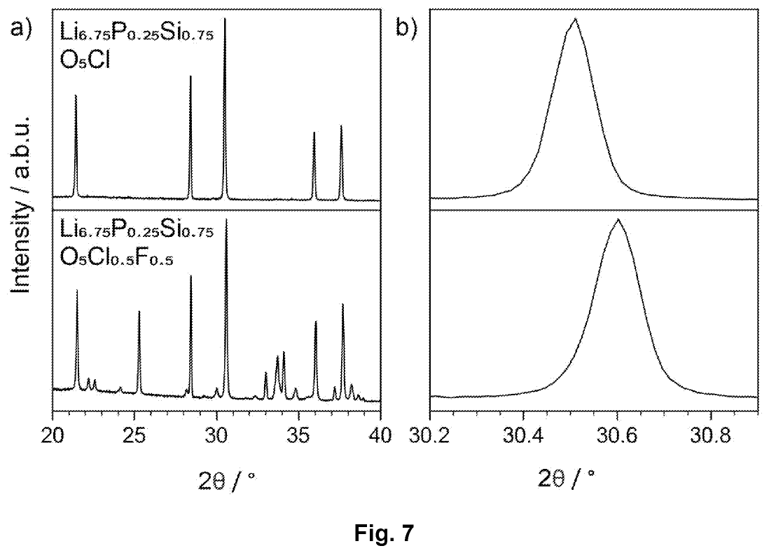

XRD patterns were collected for Li_{6.75}P_{0.25}Si_{0.75}O₅Cl_{0.5}F_{0.5} and the cubic argyrodite phase was present in the sample. A peak shift to higher 2θ values compared to the pure chloride Li_{6.75}P_{0.25}Si_{0.75}O₅Cl suggests the successful incorporation of the smaller F into the lattice (r_{(Cl)}: 1.81 Å, r_{(F)}: 1.33 Å). FIG. 7 shows a) Powder XRD patterns for Li_{6.75}P_{0.25}Si_{0.75}O₅Cl and Li_{6.75}P_{0.25}Si_{0.75}O₅Cl_{0.5}F_{0.5} confirming the presence of the cubic argyrodite phase; b) focusing on cubic argyrodite peak around 30° to highlight peak shift to higher 2θ values for the fluorine analogue.

Although a few preferred embodiments have been shown and described, it will be appreciated by those skilled in the art that various changes and modifications might be made without departing from the scope of the invention, as defined in the appended claims.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

The term “consisting of” or “consists of” means including the components specified but excluding addition of other components.

Whenever appropriate, depending upon the context, the use of the term “comprises” or “comprising” may also be taken to encompass or include the meaning “consists essentially of” or “consisting essentially of”, and may also be taken to include the meaning “consists of” or “consisting of”.

For the avoidance of doubt, wherein amounts of components in a composition are described in wt %, this means the weight percentage of the specified component in relation to the whole composition referred to.

The optional features set out herein may be used either individually or in combination with each other where appropriate and particularly in the combinations as set out in the accompanying claims. The optional features for each aspect or exemplary embodiment of the invention as set out herein are also to be read as applicable to any other aspect or exemplary embodiments of the invention, where appropriate. In other words, the skilled person reading this specification should consider the optional features for each exemplary embodiment of the invention as interchangeable and combinable between different exemplary embodiments.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. A solid crystalline material of formula (I):
LiₐMY₄XZ;
wherein:
a is from 5 to 8;
M is selected from Si, Al, Sb, Sn, B, Ga and Ge, a mixture thereof, or a mixture thereof comprising P₁₋ₓM′ₓ, wherein M′ is selected from Si, Al, Sb, Sn, B, Ga and Ge or a mixture thereof and wherein 0<x≤1;
wherein when M is Si at least one of X and Z is O;
Y is O_{1-b}S_{b}, wherein b is from 0 to 0.5; and
X and Z are each independently selected from O, S, F, Cl, Br, I or a mixture thereof.

2. The solid crystalline material according to claim 1, having an argyrodite crystal structure.

3. The solid crystalline material according to claim 1, having a crystal structure with a space group selected from F4̅3m, F4̅3c, P2₁3, P6₃cm, Pmn2₁, Pna2₁, or Cc.

4. The solid crystalline material according to claim 1, wherein M is P₁₋ₓM′ₓ; wherein M′ is selected from Si, Al, Sb, Sn, B, Ga and Ge, or a mixture thereof and wherein 0<x≤1.

5. The solid crystalline material according to claim 1, having the formula (II):
Li₆₊ₓP₁₋ₓSiₓY₄XZ;
wherein:
x is greater than 0 and up to 1.
Y is O_{1-b}S_{b} and wherein b is from 0 to 0.5; and
X and Z are each independently selected from O, S, F, Cl, Br, I or a mixture thereof.

6. The solid crystalline material according to claim 1, wherein Y is O.

7. The solid crystalline material according to claim 1, wherein X is O.

8. The solid crystalline material according to claim 1, wherein Z is Cl or Br.

9. The solid crystalline material according to claim 1, having the formula (III) Li₆₊ₓP₁₋ₓSiₓO₅Z; wherein 0<x≤1 and Z is Cl or Br, or mixture thereof.

10. The solid crystalline material according to claim 1, wherein x is from 0.2 to 1.

11. The solid crystalline material according to claim 1, having the formula Li₇SiO₅Cl.

12. The solid crystalline material according to claim 1, having the formula Li₇GeO₅Cl.

13. The solid crystalline material according to claim 1, comprising a solid solution of a solid crystalline material of formula (IV): Li₆PY₅X and a solid crystalline material of formula (V): Li₇SiY₅X, wherein:
each Y is O_{1-b}S_{b}, wherein b is from 0 to 0.5; and
each X is independently selected from F, Cl, Br and I, or mixture thereof.

14. The solid crystalline material according to claim 13, wherein the solid crystalline material of formula (IV) is Li₆PO₅Cl and the solid crystalline material of formula (V) is Li₇SiO₅Cl.

15. The solid crystalline material according to claim 13, wherein the solid crystalline material of formula (IV) and the solid crystalline material of formula (V) are present in a ratio of from 1:10 to 10:1.

16. The solid crystalline material according to claim 1, having the formula (VII):
Li₆₊ₓP₁₋ₓGeₓY₄XZ;
wherein:
$$0 < x \leq 1 .$$
Y is O_{1-b}S_{b} and wherein b is from 0 to 0.5; and
X and Z are each independently selected from O, S, F, Cl, Br, I or a mixture thereof.

17. The solid crystalline material according to claim 1, having the formula (IX): Li₆₊ₓP₁₋ₓSiᵥGe_{w}Y₄XZ;
wherein:
$$0 < x < 1 ;$$
$$0 < v < 1 ;$$
$$0 < w < 1 ;$$
$$v + w = x ;$$
Y is O_{1-b}S_{b} and wherein b is from 0 to 0.5; and
X and Z are each independently selected from O, S, F, Cl, Br, I or a mixture thereof.

18. A solid-state battery comprising:
an anode;
a cathode; and
an electrolyte comprising a solid crystalline material according to claim 1.

19. A method of preparing a solid crystalline material according to claim 1, the method comprising the steps of:
(a) admixing a source of Li, a source of MYₙ, a source of X, a source of Z and optionally a source of PY₄; wherein n=2 to 4.
(b) heating the mixture obtained in step (a);
wherein M is selected from Si, Al, Sb, Sn, B, Ga and Ge, or a mixture thereof or comprises P₁₋ₓM′ₓ; wherein M′ is selected from Si, Al, Sb, Sn, B, Ga and Ge, or a mixture thereof and wherein 0<x≤1;
wherein when M is Si and at least one of X and Z is O;
Y is O_{1-b}S_{b}, wherein b is from 0 to 0.5; and
X and Z are each independently selected from O, S, F, Cl, Br, I or a mixture thereof.

20. The method according to claim 19, wherein the solid crystalline material is Li₆₊ₓP₁₋ₓSiₓO₅Cl, step (a) of the method involves admixing Li₄SiO₄, Li₂O, and LiCl, and step (b) involves heating the mixture obtained in step (a) to a temperature of from 300 to 1000° C.

21. (canceled)

22. (canceled)
